(19) United States
(12) Patent Application Publication
(10) Pub. No.: US 2009/0187650 A1
(43) Pub. Date: Jul. 23, 2009

(54) Method and system for determining probability for availability in an instant message system

(76) Inventors: Ezequiel Cervantes, Tucson, AZ (US); Mario Francisco Acedo, Tucson, AZ (US); Matthew J. Ward, Vail, AZ (US); Paul Anthony Jennas, Tucson, AZ (US); Jason L. Peipelman, Vail, AZ (US)

Correspondence Address: MAXVALUEIP CONSULTING LLC, 11204 ALBERMYRTLE ROAD, POTOMAC, MD, 20854, US

(21) Appl. No.: 12/015,644

(22) Filed: Jan. 17, 2008

(51) Int. Cl. G06F 15/173

(52) U.S. Cl. 709/224

(57) ABSTRACT

This invention provides a method or a system to track, query, and display an accurate time for the availability of other users in an instant messaging environment. The solution provides an advantage over the known solutions by providing an accurate estimation of the time for the user to be online, thus avoiding waiting for the person to log on during a timeframe where the person typically does not log on. This is a common occurrence where team members are located on the other side of the world.

### BACKGROUND OF THE INVENTION

Instant messaging software is a useful and widely used tool for employee communication in today's global workplace. Because of time zone differences and/or personal work schedule preferences it is often difficult to know when a particular user will be logged on. Instant messaging systems have also become a very important part of the general population as well. Some of the more popular messaging systems such as Microsoft's Live Messenger and Yahoo's Instant Messenger are widely used by the public for free. The more corporate friendly version of Instant Messaging system such as IBM's Notes Buddy is more popular among the corporations. Instant messaging systems have allowed employees of corporations to conduct meetings and collaborations from remote locations. Instant messaging is now built as an integral part of many collaboration software packages and distance learning enterprise packages such as SABA and Blackboard. When one user wants to chat with a remote user that is not currently logged on, it is hard to predict when the remote user will be logged into the system again. The only known solution is to set an alert that notifies a user when another user comes online. The drawback is that the alert does not predict the most likely timeframe the user will be logged on. Furthermore, alerts sometimes will go unnoticed.

### SUMMARY OF THE INVENTION

This invention provides a mechanism to track, query, and display an accurate timeframe for the availability of other users in an instant messaging environment. The advantage of this solution over the known solution is that now we can have a good estimate of when a user will be online, thus avoiding waiting for the person to log on during a timeframe where the person typically does not log on. This is a common situation where team members are located on the other side of the world. This invention is applicable to the corporations with mission critical meetings and collaborative meetings as well as public messaging systems.

### BRIEF DESCRIPTION OF THE DRAWINGS

FIG. 1 is a schematic diagram of the system in its entirety.

FIG. 2 is a data flow diagram showing the order at which various actions are taken within the system.

### DETAILED DESCRIPTION OF THE PREFERRED EMBODIMENTS

The workings of this invention are by collecting statistics of the different connectivity states of a user. These states can include a user logging in, logging off, goes to do-not-disturb, and other state changes.

A preferred implementation may consist of a server that monitors the usage statistics of several different users and stores this information in a database. In this case the database is updated every time there is a state change in the user's availability (available, away, in a meeting, do not disturb, and unavailable). This update includes the user's username, the time at which the change happened, the state it was coming from, and the state it was going to. For a more complex system, more statistics can be recorded (such as messaging activity of the user, the vacation schedule of the user, site/national/religious holidays, current IP location of the user, etc.).

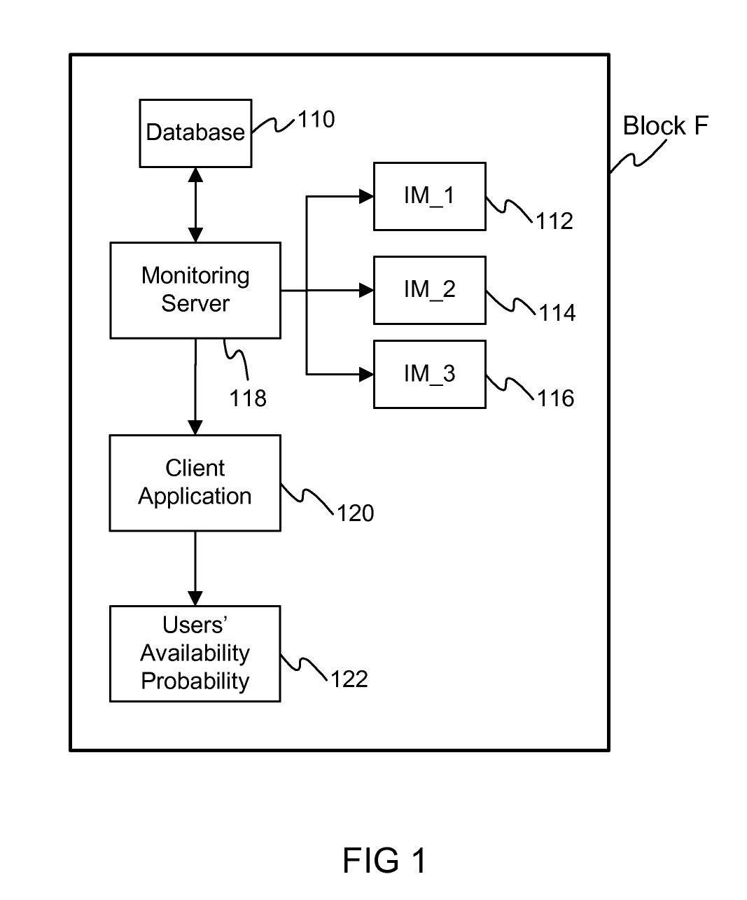

FIG. 1 is a depiction of the system whereby the data is collected by a server and stored in a database (110), in order to be extracted by the client application to be displayed for the user. The data is processed by the server based on various criteria and the granularity that is needed by the user.

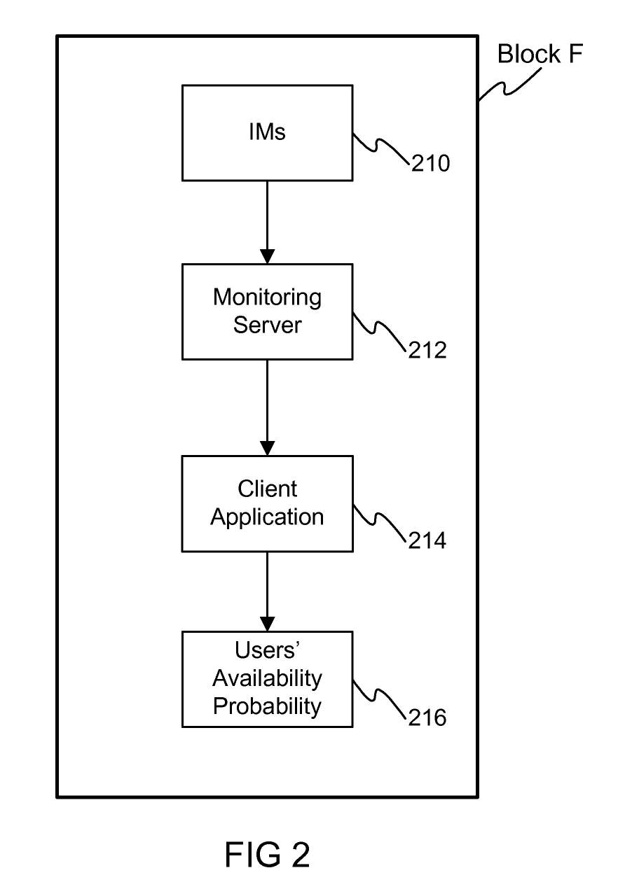

FIG. 2 is a depiction of the different major components of the preferred embodiment of the invention.

A client application that queries this information from the monitoring server's database could then use the following algorithm to display the user's availability probability at any given time . . .

{
* @param samples: An object containing (or able to access) all samples stored in the
monitoring server.
* @param username: The username as it appears in the database. Availability
information will be returned for this user.
* @param state: The STATE constant. One of AVAILABLE, AWAY, IN_MEETING,
DO_NOT_DISTURB, and UNAVAILABLE.
* @param time: The unique time (represents the millisecond, second, hour, day, month,
and year) that the availability information will be return for.
* @return a number between 0 and 1 showing the probability the that the given user is in
the given state at the given time. It does this using the samples as a historical reference.
}
double getAvailabilityProbability(SampleSet samples, String username, int state, long
time)

In this simple example the above method could search for the user's status for the last N weekdays at the time given. It would then average the amount of time the user was in the given state, and return that divided by N. Other more complex implementations can use a much more sophisticated probability suite. (e.g., by considering the future vacation/holiday/meeting schedules and their correlation to the availability data in the past.)

The output of this process could appear as a graph of the user's availability over a given timeframe. A graph can be a theoretical representation of a user's day to day habits. For example a user that normally comes to work around 7:30 am, has daily meetings between 9 am-10 am and 2 pm-3 pm. His lunch is anywhere from 30 minutes to an hour and he only takes it about half the time. He normally has other things come up in the evening hours (reduced availability after lunch), and leaves for home around 4:30 pm to 5:00 pm.

Another embodiment of the invention can be stated as below:

A method for determining the probability of availability in an instant messaging system, the method comprising the steps of:

a user using the instant messaging system;

monitoring the user's usage statistic and habits;

wherein the user's usage statistic and habits is based on log-in, log-out, duration of usage, frequency of usage, local time, history, vacation, holiday, identities and the corresponding probability of instant message recipients receiving instant message from the user, identities and the corresponding probability of instant message senders sending instant message to the user, topics and the corresponding probability of instant messages, contexts and the corresponding probability of instant messages, backup people receiving messages if the user is not available, message forwarding devices in case the instant messaging system is down, attachments of instant messages, and correlation with events in a calendar;

collecting the user's usage statistic and habits;

storing the user's usage statistic and habits in a database;

determining a state of the user;

wherein the state of the user comprising of available state, away state, in-meeting state, do-not-disturb state, and unavailable state;

determining a change of the state of the user;

tracking the old state of the user and the new state of the user;

updating the database, based on the change of the state of the user;

querying a statistical data from the database; and

determining the probability of the state of the user at a given time, based on the queried statistical data and correlation between historical information and current information.

Any variations of the above teaching are also intended to be covered by this patent application.

1. A method for determining the probability of availability in an instant messaging system, said method comprising the steps of:
a user using said instant messaging system;
monitoring said user's usage statistic and habits;
wherein said user's usage statistic and habits is based on log-in, log-out, duration of usage, frequency of usage, local time, history, vacation, holiday, identities and the corresponding probability of instant message recipients receiving instant message from said user, identities and the corresponding probability of instant message senders sending instant message to said user, topics and the corresponding probability of instant messages, contexts and the corresponding probability of instant messages, backup people receiving messages if said user is not available, message forwarding devices in case said instant messaging system is down, attachments of instant messages, and correlation with events in a calendar;
collecting said user's usage statistic and habits;
storing said user's usage statistic and habits in a database;
determining a state of said user;
wherein said state of said user comprising of available state, away state, in-meeting state, do-not-disturb state, and unavailable state;
determining a change of said state of said user;
tracking the old state of said user and the new state of said user;
updating said database, based on said change of said state of said user;
querying a statistical data from said database; and
determining the probability of said state of said user at a given time, based on said queried statistical data and correlation between historical information and current information.
